(19) United States
(12) Patent Application Publication
(10) Pub. No.: US 2019/0291062 A1
(43) Pub. Date: Sep. 26, 2019

(54) SYSTEMS AND METHODS FOR CARBONATING LIQUID IN A CONTAINER AND DETECTING CARBON DIOXIDE LEVELS IN A CARBON DIOXIDE SOURCE

(71) Applicant: BEDFORD SYSTEMS LLC, Bedford, MA (US)

(72) Inventors: Barry Wood, Norwood, MA (US); Robert M. Pelovitz, Nashua, NH (US); Nicholas Weber, Brookline, MA (US); Qian Gao, North Billerica, MA (US)

(21) Appl. No.: 16/362,317

(22) Filed: Mar. 22, 2019

Related U.S. Application Data
(60) Provisional application No. 62/646,622, filed on Mar. 22, 2018.

(51) Int. Cl. B01F 3/04; B01F 3/08; B01F 15/00; A47J 31/40; A47J 31/44; B67D 1/00; B67D 1/12; B67D 1/08

(52) U.S. Cl. CPC B01F 3/04794; B01F 3/088; B01F 15/00162; B01F 15/00357; A47J 31/407; A47J 31/4492; B01F 2215/0022; B67D 1/0071; B67D 1/1252; B67D 1/0888; B01F 2003/049; B01F 2003/0896; B67D 1/0021

(57) ABSTRACT

A system or method for carbonating a liquid includes receiving, in a sealed container of a carbonator of a drink dispenser system, a predetermined amount of liquid, identifying a predetermined carbonation level associated with a flavoring material, and setting a target pressure of the sealed container based on the predetermined carbonation level. The target pressure is selected from a plurality of different target pressures. The system or method also can include releasing pressurized carbon dioxide from a carbon dioxide source into the sealed container holding the predetermined amount of the liquid therein until an internal pressure of the sealed container is substantially equal to the target pressure. The system or method can also include dispensing, into a drink container, the flavoring material and the liquid from the sealed container of the carbonator.

### CROSS-REFERENCE TO RELATED APPLICATION

This patent application is a non-provisional patent application of, and claims priority to, U.S. Provisional Application No. 62/646,622 filed Mar. 22, 2018, titled “Systems and Methods for Carbonating Liquid in a Container and Detecting Carbon Dioxide Levels in a Carbon Source,” the disclosure of which is hereby incorporated herein by reference in its entirety.

### FIELD

The present disclosure relates to systems and methods for carbonating a precursor liquid, and more particularly, to selectively carbonating a precursor liquid in a beverage machine.

### BACKGROUND

Carbonation systems form carbonated water by dissolving carbon dioxide gas in water. However, carbonation systems, especially smaller residential carbonation systems, are typically inefficient. For example, conventional carbonation systems often use excess amounts of carbon dioxide during the carbonation process, thus unnecessarily depleting carbon dioxide sources and creating an additional cost to the consumer.

As such, manufacturers and users of carbonation systems continue to seek new and improved carbonation devices.

### SUMMARY

In an embodiment, a method of carbonating a liquid is disclosed. The method includes receiving, in a sealed container of a carbonator of a drink dispenser system, a predetermined amount of liquid. The method also includes identifying, with a processor of the drink dispenser system, a first predetermined carbonation level associated with a first flavoring material. The method also includes setting a first target pressure of the sealed container based on the first predetermined carbonation level. The first target pressure is selected from a plurality of different target pressures. The method also includes releasing pressurized gas, such as carbon dioxide, from a pressurized gas source into the sealed container holding the predetermined amount of the liquid therein until an internal pressure of the sealed container is substantially equal to the first target pressure. The method also includes dispensing, into a first drink container, (1) the first flavoring material from the drink dispenser system and (2) the liquid from the sealed container of the carbonator.

In another embodiment, a drink dispenser system is disclosed. The drink dispenser system includes a reservoir, a carbon dioxide source, a carbonator, at least one dispensing assembly, and a controller including a processor. The reservoir is configured to hold a liquid therein. The carbonator includes a sealed container, an inlet, a carbonation gas inlet, a carbonated liquid outlet, and a pressure sensor. The inlet is fluidly coupled to the reservoir and configured to selectively release a predetermined amount of the liquid from reservoir into the sealed container. The carbonation gas inlet is fluidly or gaseously coupled to the carbon dioxide source and configured to selectively release pressurized carbon dioxide from the carbon dioxide source into the sealed container. The carbonated liquid outlet is configured to release the liquid from the sealed container. The pressure sensor is configured to determine an internal pressure of the sealed container. The at least one dispensing assembly is configured to dispense the liquid and flavoring material into a first drink container. The controller including the process is configured to identify a first predetermined carbonation level associated with a first flavoring material and to set a first target pressure of the sealed container when the sealed container is holding the predetermined amount of the liquid from the reservoir. The first target pressure of the sealed container is based on the first predetermined carbonation level and selected from a plurality of different target pressures. The controller including the process is also configured to coordinate releasing the pressurized carbon dioxide into the sealed container when the sealed container is holding the predetermined amount of liquid from the reservoir. The controller including the process also is configured to determine an internal pressure of the sealed container as the pressurized carbon dioxide is released into the sealed container. The controller including the process also is configured to coordinate inhibiting release of the pressurized carbon dioxide from the carbon dioxide source into the sealed container when the internal pressure of the sealed container is substantially equal to the first target pressure. The controller including the process also is configured to coordinate dispensing the liquid and the first flavoring material from the one or more dispensing assemblies into a first drink container.

In another embodiment, a method of determining an amount of carbon dioxide in a carbon dioxide tank of a drink dispenser system is disclosed. The method includes releasing pressurized carbon dioxide from the carbon dioxide source of the drink dispenser system into a sealed container of a carbonator of the drink dispenser system holding a predetermined amount of liquid until an internal pressure of the sealed container is substantially equal to a first target pressure. The method also includes determining a first time when the pressurized carbon dioxide from the carbon dioxide tank began to be released from the carbon dioxide tank into the sealed container holding the predetermined amount of liquid therein. The method also includes determining a second time when release of the pressurized carbon dioxide from the carbon dioxide tank into the sealed container was inhibited. The method also includes determining a carbon dioxide release time by determining a difference between the first time and the second time. The method also includes determining the amount of carbon dioxide remaining in the carbon dioxide tank after the release of the pressurized carbon dioxide from the carbon dioxide tank into the sealed container has been inhibited using at least the carbon dioxide release time.

Features from any of the disclosed embodiments can be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 depicts a perspective view of a drink dispenser system, according to an exemplary embodiment.

FIG. 2 depicts a block diagram of a drink dispenser system, according to an exemplary embodiment.

FIG. 3A depicts an example beverage pod and camera of a drink dispenser system.

FIG. 3B depicts a sample configuration of the block diagram of FIG. 2 in response to an analysis of the beverage pod of FIG. 3A.

FIG. 4A depicts another example beverage pod and a camera of a drink dispenser system.

FIG. 4B depicts a sample configuration of the block diagram of FIG. 2 in response to an analysis of the beverage pod if FIG. 4A.

FIG. 5 depicts a graph of a pressurized gas volume over time.

FIG. 6 is a flowchart of a method of carbonating a liquid, according to an exemplary embodiment.

FIG. 7 is a flowchart for a method of determining an amount of carbon dioxide in a carbon dioxide tank of a drink dispenser system, according to an exemplary embodiment.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, can not necessarily be presented or illustrated to scale, and are not intended to indicate any preference or requirement for an illustrated embodiment to the exclusion of embodiments described with reference thereto.

### DETAILED DESCRIPTION

Embodiments disclosed herein include systems and methods for carbonating liquid in a container and detecting carbon dioxide levels in a carbon dioxide source. Some of the methods and systems disclosed herein can be utilized to carbonate individual drinks or beverages to certain preferred levels based on a selected flavoring material. Systems and methods disclosed herein can, by way of example, be used in home or office settings to carbonate and flavor individual drinks for a user based on a flavoring selection made by the user. Once carbonated to a predetermined level based on the flavoring material, the drink can be dispensed to a drink container of the user, such as a bottle or a cup.

The drink dispenser systems and methods disclosed herein can include various embodiments of reservoirs, carbon dioxide sources or tanks, carbonators, dispensing assemblies, controllers, or other components of drink dispenser systems. In some embodiments, drink dispenser systems and methods disclosed herein can include any components of known drink dispenser systems, such as systems and components disclosed in U.S. Pat. No. 9,381,476 titled “Drink Dispenser” to Vermeulen, et al., the disclosures of which are incorporated herein, in their entirety, by this reference. While the present exemplary systems and methods are described as optimizing and tuning the use of a carbon dioxide source, such as a pressurized canister, any number of remote carbon dioxide sources, such as a pressurized line, can be used and optimized according to the systems and methods disclosed herein. Additionally, any number of pressurized gasses can be used in place of the carbon dioxide including, but in no way limited to, nitrogen.

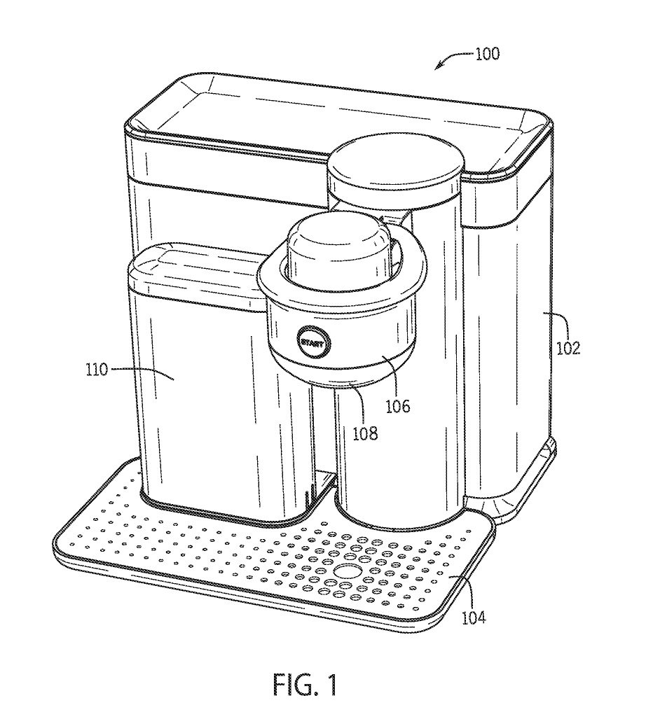

FIG. 1 is a perspective view of a drink dispenser system 100, according to an embodiment. The drink dispenser system 100 is sized for use in a home or office setting. As shall be described in greater detail throughout this disclosure, the drink dispenser system 100 can be configured to repeatedly carbonate, flavor, and dispense single-sized amounts of liquid to a user. For example, the drink dispenser system 100 can be configured to repeatedly carbonate, flavor, and dispense a volume of liquid between about 50 mL and about 4000 mL. In some embodiments, the drink dispenser system 100 can be configured to repeatedly carbonate, flavor, and dispense a volume of liquid between about 75 mL and about 3000 mL. In some embodiments, the drink dispenser system 100 can be configured to repeatedly carbonate, flavor, and dispense a volume of liquid between about 100 mL and about 2500 mL. In some embodiments, the drink dispenser system 100 can be configured to repeatedly carbonate, flavor, and dispense a volume of liquid between about 150 mL and about 2000 mL. In some embodiments, the drink dispenser system 100 can be configured to repeatedly carbonate, flavor, and dispense a volume of liquid between about 200 mL and about 1500 mL.

The drink dispenser system 100 includes a housing 102 and a platform 104. The platform 104 can include a surface configured to allow a drink container to be positioned thereon and below the dispensing assembly housing 106. The housing 102 can include a singular housing or a plurality of housings configured to house one or more components of the drink dispenser system. For example, the housing 102 can be configured to house one or more of a carbon dioxide source (such as a carbon dioxide tank) and a carbonator. In some embodiments, the carbon dioxide source can be housed in a specific carbon dioxide tank housing portion of the housing 102 or the carbonator can be housed in a specific carbonator housing portion of the housing 102. In some embodiments, the housing 102 can house a reservoir configured to hold a liquid therein. In other embodiments, the drink dispenser system 100 can be void of a reservoir in the housing 102, and liquid can be provided into the housing through a liquid line or other liquid source external to the housing 102.

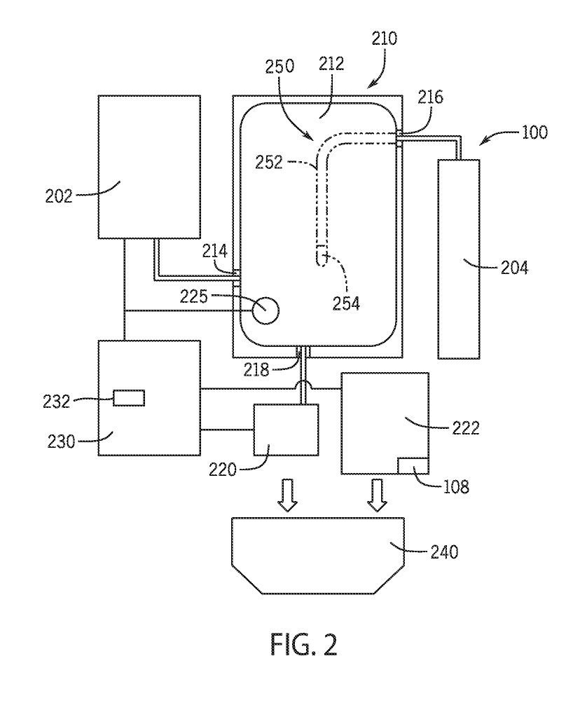

In many embodiments, the housing 102 can include a dispensing assembly housing 106. The dispensing assembly housing 106 can contain one or more components of at least one dispensing assembly. In some embodiments, the dispensing assembly housing 106 can contain at least a portion of each of a carbonated liquid dispensing assembly and a flavoring material dispensing assembly, including the a portion of any of the components or systems described with respect to FIG. 2 (e.g., the carbonator 210). Although dispensing assembly housing 106 can house one or more components of at least one dispensing assembly, a portion of the at least one dispensing assembly, such as a dispensing nozzle, can extend outside of the dispensing assembly housing.

The dispensing assembly housing 106 can also be configured to receive a flavoring package. The flavoring package can include a single-use package of a flavoring material. For example, the single-use package of the flavoring material can include a pod or other container holding the flavoring material therein. Flavoring packages can include, but are not limited to known containers for dispensing a substance, such as systems and components disclosed in U.S. Pat. No. 9,676,538 titled “Dispensing of a Substance” to Evers, et al., and U.S. patent application Ser. No. 14/502,499 title “Container for Dispensing a Substance” to Scholvinck, et al., the disclosures of each of which are incorporated herein, in their entirety, by this reference. The flavoring packages can include any number of components including, but in no way limited to, concentrated soda-pop syrup, alcohol, concentrated spirits, beer concentrate, and combinations thereof. A flavor dispensing assembly or other dispensing assembly housed in the dispensing assembly housing 106 can be configured to dispense the flavoring from the flavoring package into a drink container, either before mixing with a carbonated liquid or after mixing with a carbonated liquid.

The drink dispenser system 100 also can include a code reader 108. In some embodiments, such as the embodiment shown in FIG. 1, the code reader 108 can be positioned on or proximate to an underside of the dispensing assembly housing 106. In other embodiments, the code reader 108 can be positioned anywhere on the housing 102 of the drink dispenser system 100. The code reader 108 can include any code reader known in the art, such as a barcode reader or a matrix barcode reader. The code reader 108 is configured to read at least a barcode or a matrix code displayed on the single-use package of the flavoring material.

The drink dispenser system 100 also can include a reservoir 110. The reservoir 110 can be a receptacle or other volume within the drink dispenser system 100 that can hold precursor liquid, such as that used to form a beverage. The reservoir 110 may be at least partially formed by the housing 102 and include a lid. In this manner, the reservoir 110 may be generally closed, for example, when the drink dispenser system 100 is extracting water from the reservoir for beverage production. When needed for refilling, the reservoir 110 may be openable by a user to add additional precursor liquid. In this regard, the reservoir 110 can be manually filled. Additionally or alternatively, the reservoir 110 can be associated with a plumbed connected in order to facilitate an automatic refill of the reservoir 110 or other water holding device of the drink dispenser system 100.

FIG. 2 is a block diagram of a drink dispenser system 100, according to one exemplary embodiment. One or more of the blocks shown in the block diagram of FIG. 2 can be arranged within or partially within the housing 102 of the drink dispenser system 100 shown in FIG. 1. In many embodiments, the drink dispenser system 100 includes a reservoir 202 configured to hold a liquid therein. For example, the reservoir 202 can be configured to hold a maximum predetermined volume of water therein. In some embodiments, however, liquid can be provided directly to the carbonator 210 from outside the drink dispenser system 100 and without the use of the reservoir 202. For example, a liquid line can provide liquid from an external source outside the drink dispenser system 100 directly to the carbonator 210.

The drink dispenser system 100 can also include a carbon dioxide source 204. For example, the drink dispenser system 100 includes a carbon dioxide tank 204 housed within the housing 102. In other embodiments, the carbon dioxide source 204 can be provided directly to the carbonator 210 from outside the drink dispenser system 100 and without the use of a carbon dioxide tank housed within the housing 102. For example, a carbonation line can provide carbon dioxide from an external source outside the drink dispenser system 100 directly to the carbonator 210.

The exemplary drink dispenser system 100 includes a carbonator 210. The carbonator 210 is configured to carbonate a predetermined amount of liquid supplied to the carbonator 210 until the internal pressure of the carbonator 210 reaches a target pressure. The carbonator 210 can include a sealed container 212, an inlet 214, a carbonation gas inlet 216, a carbonated liquid outlet 218, and a sensor 225. In one embodiment, the sensor 225 can be a sensor that is configured to detect a pressure within the sealed container 212. As described herein, the pressure within the sealed container 212 can be analyzed and used to determine a level of carbonation within the sealed container 212 and liquid held under pressure therein. It will be appreciated that the sensor 225 can generally be representative of a variety of other sensors that can be used to determine one or more characteristics of the sealed container 212. For example, the senor 225 can additionally or alternatively include a temperature sensor, a level gauge, a flow meter, and/or other sensor. One or more processing components of the beverage machine, as described herein, may use an output from any type of the sensor 225 to facilitate determining relevant characteristics of the sealed container 212 for carbonation control, among other functions.

As shown in FIG. 2, the inlet 214 is fluidly coupled to the reservoir 202 or otherwise configured to selectively release a predetermined amount of liquid into the sealed container 212. The inlet 214 can include or be associated with a valve or other flow control element. In this regard, the predetermined amount of liquid may be introduced into the sealed container 212 in a controlled or regulated manner. The carbonation gas inlet 216 is shown fluidly or gaseously coupled to the carbon dioxide source 204 and configured to selectively release pressurized carbon dioxide from the carbon dioxide source 204 into the sealed container 212. As such, the carbonated gas inlet 216 can also include or be associated with a valve or other flow control element. This can allow for release of the pressurized gas in a controlled or regulated manner. Further, the carbonated liquid outlet 218 is configured to release the liquid from the sealed container 212, typically after the liquid has been carbonated in the carbonator 210. The carbonated liquid outlet 218 too can include or be associated with a valve or other flow control element to facilitate the selective release of carbonated liquid from the carbonator 210.

In the embodiment of FIG. 2, the carbonated gas inlet 218 is show connected with an optionally nozzle assembly 250. The nozzle assembly 250 can be used to direct a flow of pressurized gas from the carbonated gas inlet and toward and into a liquid held within the sealed container 212. In this manner, rather than introduce pressurized gas into a portion of the sealed container 212 that is not necessarily filled with a liquid, the nozzle assembly can be partially inserted into the liquid of the sealed container 212 for directed introduction of gas into the fluid.

To facilitate the foregoing, the nozzle assembly 250 may include a stem 252. The stem may extend from the inlet 214 and toward a bottommost portion of the sealed container 212, such as that where liquid is most likely to gather. In this regard, the stem 252 may include a bend, however, this is not required. The nozzle assembly 250 can also include a tip 254 at the end of the stem 252. The stem 252 may be specifically calibrated for pressurized gas release into precursor liquid within the sealed container 212. For example, the tip 254 may define a specifically calibrated opening to allow for gas bubble formation of a particular size, in certain embodiments.

The drink dispenser system 100 can also include at least one dispensing assembly 220. The at least one dispensing assembly 220 is configured to dispense liquid and flavoring material into a drink container 240 resting on the platform 104. In some embodiments, a single dispensing assembly combines the liquid from the carbonator 210 and flavoring material, and then dispenses the combined liquid from the carbonator and the flavoring material into the drink container 240. In other embodiments, the drink dispenser system 100 includes both: (1) a dispensing assembly 220 configured to dispense the liquid from the carbonator 210, but not necessarily the flavoring material; and (2) a flavoring dispensing assembly 222 configured to dispense the flavoring material, but not the liquid from the carbonator 210. The flavoring dispensing assembly 222, for example, can be configured to receive, open, and/or dispense flavoring material from a single-use package of the flavoring material into the drink container 240. In some embodiments, the flavoring dispensing assembly 222 is configured to open the flavoring material from the single-use package of the flavoring material, and pass the flavoring material to the dispensing assembly 220 for mixing and/or dispensing of the flavoring material with the liquid from the carbonator 210.

In some embodiments, the code reader 108 is associated with or directly coupled to the flavoring dispensing assembly 222. In other embodiments, the code reader 108 is directly coupled to the controller 230. In still other embodiments, the code reader 108 can be positioned anywhere on the housing 102 shown in FIG. 1.

The drink dispenser system 100 also includes a controller 230. The controller includes a processor 232. The controller 230 can also include one or more non-transitory computer-readable media storing computing instructions configured to run on the processor and perform various acts. The controller 230 can be electrically or otherwise communicatively coupled to the pressures sensor 225, the carbonator 210, the inlet 214, the carbon dioxide gas inlet 216, the carbonated liquid outlet, the dispensing assembly, the flavoring dispensing assembly 222, and/or the code reader 108. Although not shown in FIG. 2, the controller 230 can be electrically or otherwise communicatively coupled to one or more valves such that the controller 230 can coordinate release of liquid, carbonated liquid, carbon dioxide, flavoring material, and/or carbonated liquid mixed with flavoring material, as described in greater detail below.

In one exemplary embodiment, the controller 230 including the processor 232 is configured to coordinate release of a predetermined amount of liquid into the sealed container 212 from the reservoir 202 or a different source of liquid. The predetermined amount of liquid released into the sealed container 212 can be the amount of liquid suitable for a single drink container. For example, the predetermined amount of liquid released into the sealed container can be between about 50 mL and about 4000 mL, between about 75 mL and about 3000 mL, between about 100 mL and about 3000 mL, between about 150 mL and about 2000 mL, or between about 200 mL and about 1000 mL. In some embodiments, the predetermined amount of liquid released into the sealed container 212 can be based on a code read from the single-use package of the flavoring materials (referenced below).

The controller 230 including the processor 232 is configured to identify a predetermined carbonation level associated with a flavoring material. In more particular embodiments, the controller 230 including the processor 232 is configured to identify the predetermined carbonation level associated with the flavoring material based on a code on a first single-use package of the flavoring material, as read by the code reader 108.

The controller 230 including the processor 232 also is configured to set a target pressure of the sealed container 212 when the sealed container 212 is holding the predetermined amount of the liquid. The target pressure of the sealed container 212 is based on the predetermined carbonation level associated with the flavoring material and also can be selected from a plurality of different target pressures. For example, a first flavoring material can be associated with a first predetermined carbonation level which correlates to a first target pressure of the sealed container 212, while a second flavoring material can be associated with a second predetermined carbonation level which correlates to a second target pressure of the sealed container 212 which is different from the first target pressure. In various embodiments, the pressure inside of the sealed container 212 can exceed 90 PSI, and the pressure within the sealed container 212 can cycle between ambient pressure, when the carbonation system is not in use, to approximately 90-100 PSI when the carbonation system is dissolving gas in liquid in the sealed container 212.

The controller 230 including the processor 232 also is configured to coordinate releasing the pressurized carbon dioxide into the sealed container 212 when the sealed container 212 is holding the predetermined amount of liquid. The controller 230 including the processor 232 also is configured to determine an internal pressure of the sealed container (using the sensor 225) as the pressurized carbon dioxide is released into the sealed container 212 from the carbon dioxide source 204. Since the sealed container 212 includes a known internal volume and because the predetermined amount of liquid includes a known volume, carbon dioxide can be introduced into the sealed container 212 in a measured fashion. By monitoring and controlling how the high the internal pressure reaches in the sealed container 212 before the carbon dioxide is stopped, the amount of carbon dioxide dissolved in the liquid in the sealed container can be controlled and predicted.

Carbonating the liquid in the sealed container to the predetermined level can thus be performed by releasing carbon dioxide into the sealed container until the internal pressures reaches the target pressure. The controller 230 including the processor 232 also is configured to coordinate inhibiting or otherwise stopping release of the pressurized carbon dioxide from the carbon dioxide source 204 into the sealed container when the internal pressure of the sealed container is substantially equal to the target pressure. In some embodiments, the controller 230 including the processor 232 is configured to coordinate inhibiting or otherwise stopping release of the pressurized carbon dioxide from the carbon dioxide source 204 into the sealed container when the internal pressure of the sealed container within a predetermined range of the target pressure.

The controller 230 including the processor 232 also is configured to coordinate dispensing the liquid and the flavoring material from the dispensing assembly 220 and/or the flavoring dispensing assembly 222 into the drink container 240. In one embodiment, the drink dispenser system 100 is configured to individually carbonate, flavor, and dispense multiple beverages to personal drink containers. Thus, the controller 230 is configured to perform the acts described above with multiple varieties of flavoring materials that can be associated with different predetermined amounts of liquid, different carbonation levels, and/or different target pressures. The controller 230 including the processor 232, is configured to coordinate selective release of a second predetermined amount of additional liquid through the water inlet into the sealed container 212 of the carbonator 210. The controller 230 including the processor 232, is configured to determine a second predetermined carbonation level association with a second flavoring material based on a second code on a second single-use package of second flavor material, as read by the code reader, the second predetermined carbonation level being different than the predetermined carbonation level.

The controller 230 including the processor 232, is also configured to set a second target pressure of the sealed container 212 when the sealed container 212 is holding the second predetermined amount of the additional liquid therein based on the second predetermined carbonation level and selected from the plurality of different target pressures. The controller 230 including the processor 232, is configured to coordinate releasing pressurized carbon dioxide from the carbon dioxide source into the sealed container 212 when the sealed container 212 is holding the second predetermined amount of the additional liquid therein. The controller 230 including the processor 232, is also configured to determine the internal pressure of the sealed container 212 as the additional pressurized carbon dioxide is inserted into the sealed container 212. The controller 230 including the processor 232, is also configured to coordinate inhibiting release of the additional pressurized carbon dioxide from the carbon dioxide source into the sealed container when the internal pressure of the sealed container 212 is substantially equal to the second target pressure. The controller 230 including the processor 232, is further configured to coordinate dispensing, into a second drink container, the additional liquid and the second flavoring material from the dispensing assembly 220 and/or the flavoring dispensing assembly 222 into a drink container.

Embodiments of the drink dispenser system 100 can also be configured to determine an amount of carbon dioxide remaining in the carbon dioxide source 204. More specifically, the controller 230 including the processor 232 can be configured to determine an amount of carbon dioxide remaining in the carbon dioxide source 204 after the release of the pressurized carbon dioxide from the carbon dioxide source into the sealed container 212 has been inhibited or stopped. The amount of carbon dioxide remaining in the carbon dioxide source after the release of the pressurized carbon dioxide from the carbon dioxide source into the sealed container has been inhibited can be determined by determining a carbon dioxide release time. The controller 230 including the processor 232 can be configured to (1) determine a first time when the pressurized carbon dioxide from the carbon dioxide source 204 began to be released from the carbon dioxide source 204 into the sealed container 212 holding the predetermined amount of liquid therein, and (2) determine a second time when release of the pressurized carbon dioxide from the carbon dioxide source 204 into the sealed container 212 was inhibited by reaching a target pressure. The controller 230 including the processor 232 can determine the carbon dioxide release time by determining a difference between the first time and the second time.

The controller 230 including the processor 232 can be configured to determine the amount of carbon dioxide remaining the carbon dioxide source after the release of the pressurized carbon dioxide from the carbon dioxide source into the sealed container has been inhibited using at least the carbon dioxide release time and one or more of an empty weight of the carbon dioxide tank when the carbon dioxide tank is empty, a filled weight of the carbon dioxide tank when the carbon dioxide tank is initially filled, an ambient temperature proximate to the dioxide tank, the first target pressure, and an amount of carbon dioxide required to pressurize the sealed container to the first target pressure.

Through empirical testing with a carbon dioxide tank, a carbonation time profile can be created for any specific target pressures. This carbonation time profile can show an inflection point at which the consumption of carbon dioxide from the carbon dioxide tank will turn from some liquid carbon dioxide to completely gaseous carbon dioxide. When the carbon dioxide tank includes only gaseous carbon dioxide and little to no liquid carbon dioxide, the level of carbon dioxide in the carbon dioxide tank is likely sufficient to carbonate only one or two more drinks before the carbon dioxide tank is completely depleted of carbon dioxide. In some embodiments, the controller 230 including the processor 232 can be configured to display an alert on an interface of the controller 230 when the amount of carbon dioxide remaining in the carbon dioxide source, as determined, is below a predetermined level.

As described herein, the carbonator 210 and associated systems and subsystems can be used to selectively carbonate a precursor liquid. For example, a first beverage pod can be used to create a beverage having a first carbonation level and a second beverage pod can be used to create another beverage having a second carbonation level, different than the carbonation level of the first beverage. The carbonator 210 helps account for such differences by allowing for production of carbonated precursor liquid having different carbonation levels. This is facilitated along with, for example, the code reader 108 that reads a code or other information form a beverage container including instructions for making the beverage, and the controller 230 including the processor 232 for analyzing the instructions and controlling operations of the carbonator 210 to make the precursor liquid having the particular carbonation levels.

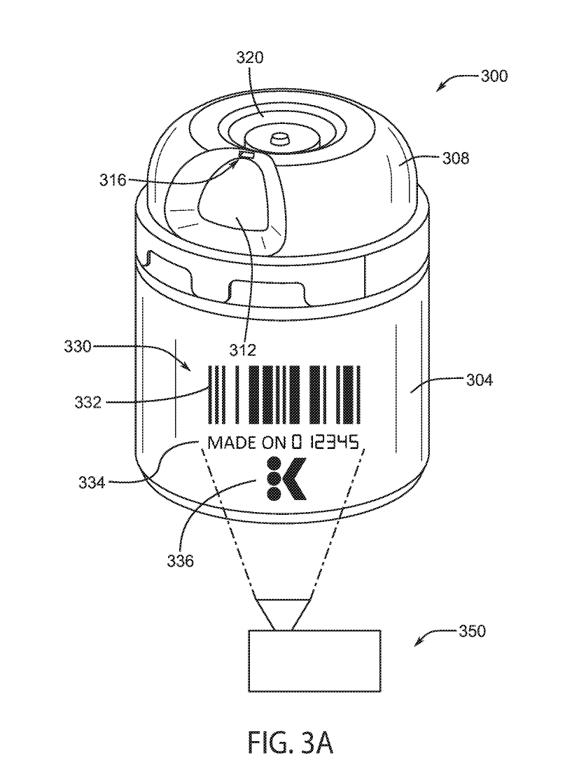

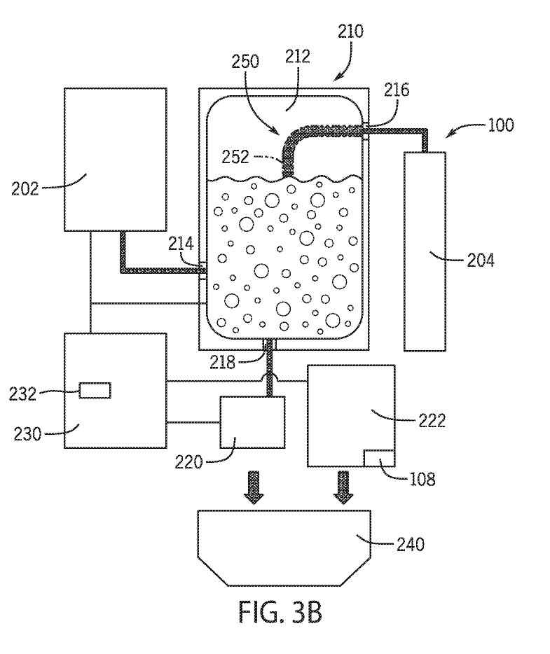

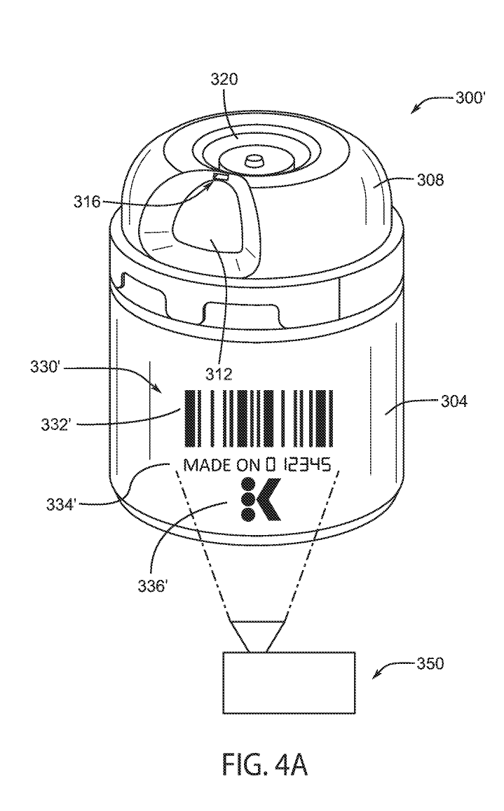

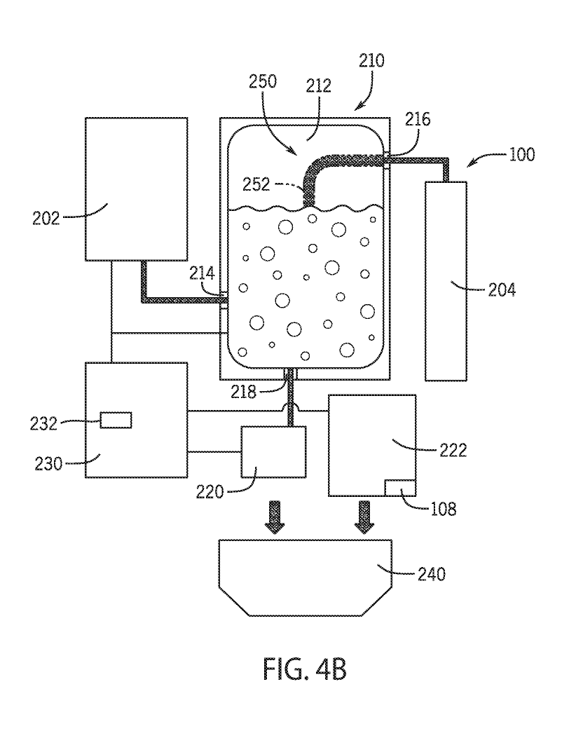

In this regard, FIGS. 3A-4B depict sample use cases of the drink dispenser system 100 producing carbonated water having different levels of carbonation. With reference to FIG. 3A, a beverage cartridge 300 is shown. The beverage cartridge 300 can generally operate to hold a beverage medium, such as that described as being releasable from the dispensing assembly 222 described herein.

While many constructions are possible, FIG. 3A shows that beverage cartridge 300 including a container 304 and a cap 308. The cap 308 can enclose a sealed volume of the container 304 that holds the beverage medium. Other sample features shown include an alignment feature 312, which can include a scalloped portion of the cap 308. The alignment feature 312 can help guide the cartridge into a proper position within a beverage machine, such as a proper position within the dispensing assembly 222. Arranged within the alignment feature is a gas inlet 316. The gas inlet 316 can generally receive pressurized gas from a gas source, such as the source 204, in order to facilitate beverage medium release.

Also shown in FIG. 3A, is a topmost portion of a rolling diaphragm 320. The rolling diaphragm 320 may be impacted by various components of the dispensing assembly 222 in order to release beverage medium from the cartridge 300. For example, the rolling diaphragm 320 may be associated with an internal piercing element, and thus movement of the rolling diaphragm 320 inward can cause the internal piercing element to puncture a seal of the cartridge 300 for release of the beverage medium. In other embodiments, the system can be associated with other beverage cartridges, and thus the beverage cartridge 300 is shown as an example.

The beverage cartridge 300 can include a code 330. The code 330 can include a variety of information associated with cartridge, including information regarding instructions for preparation of a beverage. The code 330 can also include other information, including information regarding a date for when the cartridge 300 was assembled, as well as information regarding the authenticity of the cartridge 300. In this regard, the sample code 330 shown in FIG. 3A include a barcode section 332, a date section 334, and a design section 336.

The drink dispenser systems described herein can generally operate to obtain information about the cartridge 300 using the code 330. For example, a camera 350 may be used to obtain images of the code 330. The camera 350 may be a reduced resolution camera to facilitate power reduction within the system. Sample pixel arrays include 120×160 and 640×480, however, in other embodiment, other camera types can be used.

In response to the camera 350 obtaining an image of the code 330, the drink dispensing system 100 can operate to perform one or more functions for producing a beverage associated with the cartridge 300. For example and with reference to FIG. 3B, the controller 230 including the processor 232 can analyze the code 330 and determine information associated with a carbonation level of the beverage to be produced with the beverage medium of the cartridge 300. As example, the controller 230 including the processor 232 can determine that a first beverage is to be producing having a first carbonation level, such as a soda having a carbonation level of 1, 2, 3, or more volumes of CO₂.

Based on this determination, the controller 230 including the processor 232 can coordinate with one or more elements of the system to produce a carbonated liquid within the sealed container 212 having the first carbonation level. For example and as described herein, the controller 230 including the processor 232 can cooperate with one or more of the reservoir 202, the carbon dioxide source 204, and the various valves and sensors of the carbonator 210 to introduce a quantity of liquid and pressurized gas into the sealed container 212 that can result in a carbonated liquid having the first carbonation level.

In this regard, FIG. 3B shows the sealed container 212 having a carbonated liquid having the first carbonation level. In facilitating production of the carbonated liquid shown in FIG. 3B, the controller 230 including the processor 232 may track one or more properties of the processes, including recording a time period during which pressurized gas is released from the source 204. As explained in greater detail below, this can be used to determine a fill level of the carbon dioxide source 204, allowing the system to indicate when the source 204 is depleted or nearly depleted.

With reference to FIG. 4A, another beverage container 300′ is shown. The beverage container 300′ can be used in the product of a second beverage that is distinct form the beverage produced using the container 304 in FIG. 3A. In this regard, the beverage container 300′ may include similar structural components, as shown in FIG. 3B; however, this is not required.

Being a different beverage cartridge, the beverage cartridge 300′ may include a code 330′ that includes information specific to the beverage cartridge 300′ and the production of the second beverage. For example, the code 330′ can include information regarding instructions for producing the second beverage (including instructions regarding producing an associated carbonation level), information regarding a production date of the beverage cartridge 300′, and/or information regarding the authenticity of the cartridge 300′. As such, the code 330′ is shown including a barcode section 332′, a date section 334′, and a design section 336′.

Substantially analogous to configuration of FIG. 3A, the camera 350 can obtain an image of the code 330 and the drink dispensing system 100 can operate to perform one or more functions for producing a beverage associated with the cartridge 300 using information obtained from the camera. For example and with reference to FIG. 4B, the controller 230 including the processor 232 can analyze the code 330′ and determine information associated with a carbonation level of the beverage to be produced with the beverage medium of the cartridge 300′. As example, the controller 230 including the processor 232 can determine that a second beverage is to be producing having a first carbonation level, such as a second soda having a carbonation level of 1, 2, 3, or more volumes of CO₂.

Based on this determination, the controller 230 including the processor 232 can coordinate with one or more element of the system to produce a carbonated liquid within the sealed container 212 having the second carbonation level. For example and as described herein, the controller 230 including the processor 232 can cooperate with one or more of the reservoir 202, the carbon dioxide source 204, and the various valves and sensors of carbonator to introduce a quantity of liquid and pressurized gas into the sealed container 212 that can result in a carbonated liquid having the second carbonation level. In this regard, FIG. 3B shows the sealed container 212 having a carbonated liquid having the second carbonation level. For purposes of illustration, the second carbonation level can be less than the first carbonation level. In facilitating production of the carbonated liquid shown in FIG. 4B, the controller 230 including the processor 232 may track one or more properties of the processes, including recording a time period during which pressurized gas is released from the source 204. Being of a lesser carbonation level then the beverage produced from the configuration of FIG. 3B, the pressurized gas from the source 204 may have entered the sealed container 212 in a lesser period of time. And as explained in greater detail below, this can be used to determine a fill level of the carbon dioxide source 204, allowing the system to indicate when the source 204 is depleted or nearly depleted.

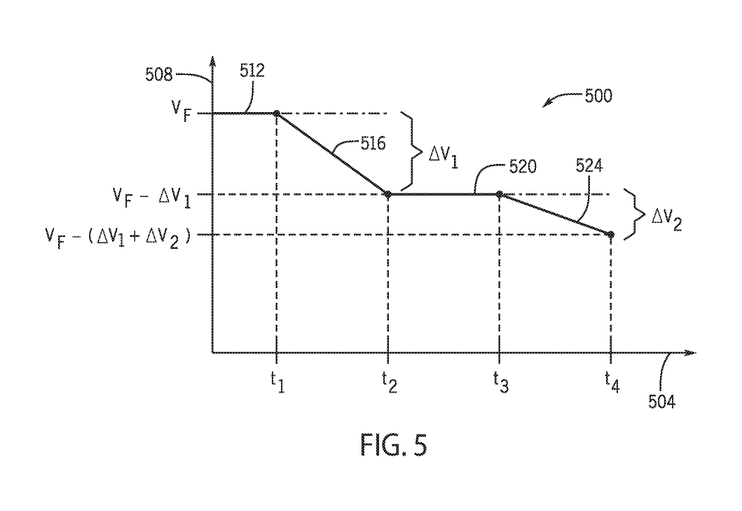

Turning to FIG. 5, a chart 500 is shown. The chart 500 is representative of a fill volume of the source 204 over time. As described herein, the drink dispenser system 100 can release pressured gas from the gas source 204 and into the sealed container 212 in order to produce a carbonated beverage. The gas source 204 can have a sufficient volume in order to allow for the production of multiple beverages, and over a period of time. The controller 230 including the processor 232 can operate in conjunction with the sensor 225 and the source 204 to track various parameters associated with the use of the source 204. These parameters can be analyzed and in turn used to determine a fill volume of the source 204. As such, the drink dispenser system 100 can determine when the source 204 is empty or nearly empty, and possibly deliver an indication to a user regarding refilling the canister.

The chart 500 provides an example history of distinct uses (and non-uses) of the source 204 over a period of time that can be used to determine a volume of carbonated gas in the source 204. In particular, the chart 500 includes a time axis 504 and a gas volume axis 508. Plotted along the time axis 504 is a curve 512. The curve 512 represents a volume of pressurized gas held within the source 204, with V_{F} corresponding to presumed maximum or “full” volume of gas. The curve 512 includes various regions that correspond to use (or non-use) of the source 204. For example, a first region 516 may correspond to a portion of the curve 512 substantially between time t₁ and t₂ on the time axis 504. The first region 516 may be indicative of use of the source 204 to produce a first carbonated beverage, such as the first carbonated beverage discussed in relation to FIG. 3A and 3B. In this regard, as the first beverage is being produced, pressurized gas is drawn from the source, represented as ΔV₁. As described herein, ΔV₁ can be determined by the controller 230 including the processor 232 using the time during which the pressurized gas was released from the source 204. For example, one or more sensors of the drink dispenser system 100 may detect the source 204 releasing gas form the time t₁ to t₂ and determine ΔV₁ assuming a given flow rate. In this manner, the curve 512 plots a decrease in the total presumed volume of the source 204 to (V_{F}−ΔV₁).

It will be appreciated that the foregoing calculation can be performed repeatedly over time for subsequent beverages and periods of non-use. For example, a second region 520 of the curve can correspond to a period of substantial non-use of the source 204. In this regard, the source 204 can be assumed to lose no pressure gas and/or a negligible amount of pressurized gas during this time. Further, a third region 524 of the curve can correspond use of the source 204 to produce a first carbonated beverage, such as the second carbonated beverage discussed in relation to FIG. 4A and 4B. In this regard, as the second beverage is being produced, pressurized gas is drawn from the source 204, represented as ΔV₂. As described herein, ΔV₂ can be determined by the controller 230 including the processor 232 using the time during which the pressurized gas was released from the source 204. For example, one or more sensors of the drink dispenser system 100 may detect the source 204 releasing gas form the time t₃ to t₄ and determine ΔV₂ assuming a given flow rate. In this manner, the curve 512 plots a decrease in the total presumed volume of the source 204 to (V_{F}−(ΔV₁+ΔV₂)).

It will be appreciated that the foregoing process can be repeated until the presumed or calculated volume of the source 204 reaches a threshold. For example, the controller 230 including the processor 232 may determine the calculated volume to be less than or equal to 10%, 5%, or other threshold. When reached, the controller 230 including the processor 232 can produce an indication for replacing the source 204.

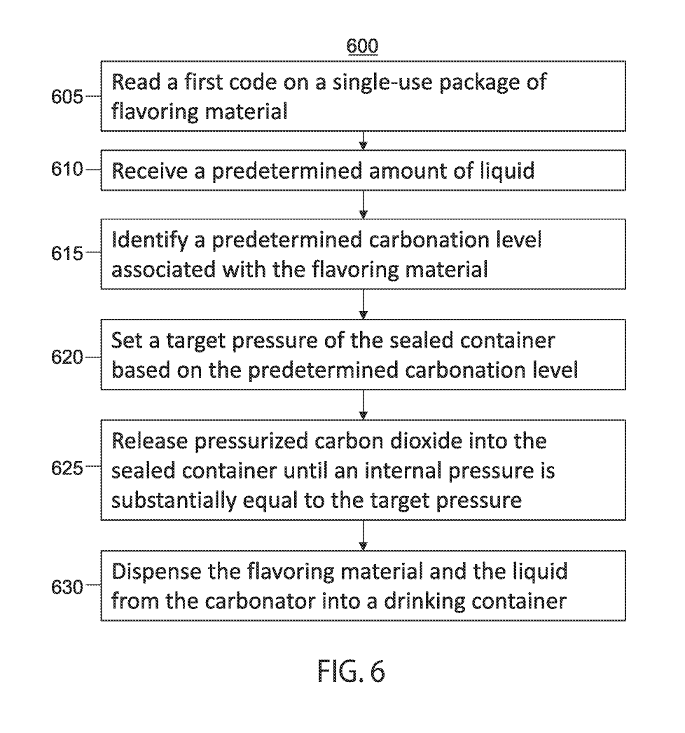

Turning now to FIG. 6, also disclosed herein is a method 600 of carbonating a liquid. Advantageous to conventional systems for carbonating liquids, embodiments of method 600 allow liquids to be carbonated to levels unique to individual flavoring materials selected by a user. For example, in many embodiments, method 600 can include an act 605 of reading a code on a single use-package of flavoring material. The flavoring material can be loaded into the drink dispenser system by the user, or the user can select on of a number of flavoring materials stored in the drink dispenser system. In some embodiments, method 600 also can include an act of receiving the single-use package of the flavoring material in a flavor dispensing assembly of the drink dispenser system. The flavor dispensing assembly is configured to dispense the flavoring material into the drink container with or without an additional dispensing assembly that dispenses the liquid from the carbonator into the drink container.

Method 600 also includes an act 610 of receiving a predetermined amount of liquid. More specifically, act 610 can include receiving, in a sealed container of a carbonator of a drink dispenser system, a predetermined amount of liquid. The predetermined amount of liquid can be received from a reservoir in the drink dispenser system or from a liquid source outside the drink dispenser system. In many embodiments, the predetermined amount of liquid is water.

Different flavoring materials can be associated with different preferred levels of carbonation. For example, a lower level of carbonation can be preferred to complement a first flavoring material, and a higher level of carbonation can be preferred to complement a second flavoring material. Method 600, thus, also includes an act 615 of identifying a predetermined carbonation level associated with the flavoring material. More specifically, act 610 can include identifying, with a processor of the drink dispenser system, a predetermined carbonation level associated with a flavoring material. In embodiments where a code on a single-use package of flavoring material has been read, act 615 can include correlating the code on the single-use package of the flavoring material with the predetermined carbonation level.

Predetermined carbonation levels can also be correlated to internal pressure readings within the sealed container as the liquid in the sealed container is carbonated. Method 600, then, also includes an act 620 of setting a target pressure of the sealed container based on the predetermined carbonation level. More specifically, act 620 can include setting a target pressure of the sealed container based on the predetermined carbonation level, the target pressure being selected from a plurality of different target pressures.

To achieve a certain level of carbonation for the individual flavoring material, the release of carbon dioxide into the sealed container is monitored. Thus, method 600 also includes an act 625 of releasing pressurized carbon dioxide into the sealed container until an internal pressure is substantially equal to the target pressure. More specifically, act 625 can include releasing pressurized carbon dioxide from a carbon dioxide source into the sealed container holding the predetermined amount of the liquid therein until an internal pressure of the sealed container is substantially equal to the target pressure.

After the liquid in the carbonator has been carbonated to the predetermined level of carbonation associated with the individual flavoring material, the carbonated liquid can be dispensed to a drink container. The carbonated liquid can be dispensed into the drinking container before being mixed with the flavoring material or after being mixed with the flavoring material. Method 600, therefore, also includes an act 630 of dispensing the flavoring material and the liquid from the carbonator into a drinking container. More specifically, act 630 can include dispensing, into a drink container, (1) the flavoring material from the drink dispenser system and (2) the liquid from the sealed container of the carbonator.

In many embodiments, method 600 is advantageous to conventional methods of carbonating a liquid because multiple flavoring materials can be used in the drink dispenser system and the drink dispenser system can carbonate liquids to different levels based on the selected flavoring materials. Thus, in some embodiments, method 600 can includes any of acts described above, but specific to different flavoring materials and/or different levels of carbonation. For example, method 600 can include an act of receiving, in the sealed container of the carbonator of the drink dispenser system, a second predetermined amount of additional liquid. Method 600 can also include an act of reading a second code on a second single-use package of a second flavoring material. Method 600 can also include an act of identifying, with the processor, a second predetermined carbonation level associated with the second flavoring material based on the second code on the second single-use package of the second flavoring material. The second predetermined carbonation level can be different than the first predetermined carbonation level. Method 600 can also include an act of setting a second target pressure of the sealed container holding the second predetermined amount of the additional liquid therein. The second target pressure can be different than the first target pressure and can be selected from the plurality of different target pressures. Method 600 can also include an act of releasing pressurized carbon dioxide from the carbon dioxide source into the sealed container holding the second predetermined amount of the additional liquid therein until an internal pressure of the sealed container is substantially equal to the second target pressure. Method 600 can also include an act of dispensing, into a second drink container, (1) the additional flavoring material from the drink dispenser system and (2) the additional liquid from the sealed container of the carbonator.

In some alternative embodiments, method 600 also can include an act of determining an amount of carbon dioxide remaining in the carbon dioxide source after the release of the pressurized carbon dioxide from the carbon dioxide source into the sealed container has been completed. Such an act can be beneficial to determine if the carbon dioxide source, such as a carbon dioxide tank requires replacing before the drink dispenser system attempts to carbonate additional liquid to combine with an additional flavoring material. In some embodiments, method 600 can also include an act of displaying an alert on an interface of the drink dispenser system when the amount of carbon dioxide remaining in the carbon dioxide source, as determined, is below a predetermined level.

The act of determining an amount of carbon dioxide in method 600 can include multiple activities. For example, determining the amount of carbon dioxide remaining the carbon dioxide source after the release of the pressurized carbon dioxide from the carbon dioxide source into the sealed container has been completed can include: first, determining a first time when the pressurized carbon dioxide from the carbon dioxide source began to be released from the carbon dioxide source into the sealed container holding the predetermined amount of liquid therein; second, determining a second time when release of the pressurized carbon dioxide from the carbon dioxide source into the sealed container was completed to a desired pressure; third, determining a carbon dioxide release time by determining a difference between the first time and the second time; and fourth, determining the amount of carbon dioxide remaining in the carbon dioxide source after the release of the pressurized carbon dioxide from the carbon dioxide source into the sealed container has been completed using at least the carbon dioxide release time.

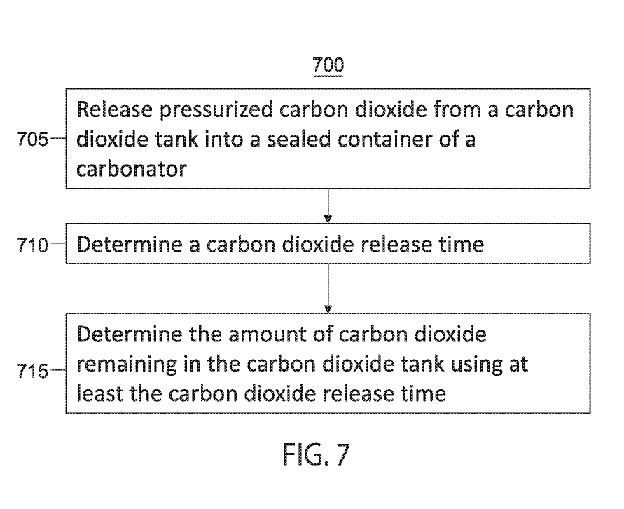

Turning now to FIG. 7, also disclosed herein is a method 700 of determining an amount of carbon dioxide in a carbon dioxide tank of a drink dispenser system 100. Embodiments of method 700 are advantageous to conventional methods because a user can be made aware if the carbon dioxide tank is low or empty before attempting to carbonate more liquid for a different drink.

Method 700 includes an act 705 of releasing pressurized carbon dioxide from a carbon dioxide tank into a sealed container of a carbonator. More specifically, act 705 can include releasing pressurized carbon dioxide from the carbon dioxide tank of the drink dispenser system into a sealed container of a carbonator of the drink dispenser system holding a predetermined amount of liquid until an internal pressure of the sealed container is substantially equal to a first target pressure.

Similar to other methods described herein, method 700 also can include a number of acts prior to act 705. For example, method 700 can include acts of reading a code on a single-use package of a flavoring material; receiving the first single-use package of the first flavoring material in a flavor dispensing assembly of the drink dispenser system, receiving, in a sealed container of the carbonator of the drink dispenser system, the predetermined amount of liquid from a reservoir of the drink dispenser system, identifying, with a processor of a controller of the drink dispenser system, a first predetermined carbonation level associated with a first flavoring material based on the first code on the first single-use package of the first flavoring material, and setting the first target pressure of the sealed container holding the predetermined amount of the liquid therein based on the first predetermined carbonation level.

Also similar to other methods described herein, method 700 also can include a number of acts after act 705. For example, method 700 can include determining an internal pressure of the sealed container as the pressurized carbon dioxide is inserted into the sealed container, inhibiting release of the pressurized carbon dioxide from the carbon dioxide tank into the sealed container when the internal pressure of the sealed container is substantially equal to the target pressure, dispensing, into the drink container, (1) the flavoring material from the flavor dispensing assembly and (2) the liquid, as carbonated, from the sealed container of the carbonator.

Method 700 includes an act 710 of determining a carbon dioxide release time. The carbon dioxide release time can be determined by identifying a difference between the first carbon dioxide release time and a second carbon dioxide release time. The first carbon dioxide release time can be determined by identifying a first time when the pressurized carbon dioxide from the carbon dioxide tank began to be released from the carbon dioxide tank into the sealed container holding the predetermined amount of liquid therein. The second carbon dioxide release time can be determined by identifying a second time when release of the pressurized carbon dioxide from the carbon dioxide tank into the sealed container was inhibited due to achieving a desired pressure within the sealed container.

Method 700 includes an act 715 of determining the amount of carbon dioxide remaining in the carbon dioxide tank using at least the carbon dioxide release time. More specifically act 715 can include determining the amount of carbon dioxide remaining in the carbon dioxide tank after the release of the pressurized carbon dioxide from the carbon dioxide tank into the sealed container has been inhibited using at least the carbon dioxide release time. Even more specifically, act 715 can include determining the amount of carbon dioxide remaining in the carbon dioxide tank after the release of the pressurized carbon dioxide from the carbon dioxide tank into the sealed container has been inhibited using the carbon dioxide release time and one or more of an empty weight of the carbon dioxide tank when the carbon dioxide tank is empty, a filled weight of the carbon dioxide tank when the carbon dioxide tank is initially filled, an ambient temperature proximate to the dioxide tank, the first target pressure, and an amount of carbon dioxide required to pressurize the sealed container to the first target pressure.

In some embodiments, a carbonation time profile for any specific target pressures can be created through empirical testing with a carbon dioxide tank. This carbonation time profile can show an inflection point at which the consumption of carbon dioxide from the carbon dioxide tank will turn from some liquid carbon dioxide to gaseous carbon dioxide. When the carbon dioxide tank includes only gaseous carbon dioxide and little to no liquid carbon dioxide, the level of carbon dioxide in the carbon dioxide tank is likely sufficient to carbonate only one or two more drinks before the carbon dioxide tank is completely depleted of carbon dioxide. In these and other embodiments, act 715 can include determining the amount of carbon dioxide remaining in the carbon dioxide tank after the release of the pressurized carbon dioxide from the carbon dioxide tank into the sealed container has been inhibited using at least the carbon dioxide release time and the carbonation time profile for the target pressure.

In some embodiments, method 700 also can include an act of displaying an alert on an interface of a controller of the drink dispenser system when the amount of carbon dioxide remaining in the carbon dioxide tank, as determined, is below a predetermined level.

While various aspects and embodiments have been disclosed herein, other aspects and embodiments are contemplated. The various aspects and embodiment disclosed herein are for purposes of illustration and are not intended to be limiting. Additionally, the words “including,” having,” and variants thereof (e.g., “includes” and “has”) as used herein, including the claims, shall be open ended and have the same meaning as the word “comprising” and variants thereof (e.g., “comprise” and “comprises”).

What is claimed is:

1. A method of carbonating a liquid, comprising:
receiving, in a sealed container of a carbonator of a drink dispenser system, a predetermined amount of liquid;
identifying, with a processor of the drink dispenser system, a first predetermined carbonation level associated with a first flavoring material;
setting a first target pressure of the sealed container based on the first predetermined carbonation level, the first target pressure being selected from a plurality of different target pressures;
releasing pressurized carbon dioxide from a carbon dioxide source into the sealed container holding the predetermined amount of the liquid until an internal pressure of the sealed container is substantially equal to the first target pressure; and
dispensing, into a first drink container, (1) the first flavoring material from the drink dispenser system and (2) the liquid from the sealed container of the carbonator.

2. The method of claim 1, further comprising:
reading a first code on a first single-use package of the first flavoring material;
wherein identifying the first predetermined carbonation level associated with the first flavoring material includes correlating the first code on the first single-use package of the first flavoring material with the predetermined carbonation level.

3. The method of claim 2, further comprising:
receiving, in the sealed container of the carbonator of the drink dispenser system, a second predetermined amount of additional liquid;
reading a second code on a second single-use package of a second flavoring material;
identifying, with the processor, a second predetermined carbonation level associated with the second flavoring material based on the second code on the second single-use package of the second flavoring material, the second predetermined carbonation level being different than the first predetermined carbonation level;
setting a second target pressure of the sealed container holding the second predetermined amount of the additional liquid therein, wherein the second target pressure is different than the first target pressure and is selected from the plurality of different target pressures;
releasing pressurized carbon dioxide from the carbon dioxide source into the sealed container holding the second predetermined amount of the additional liquid therein until an internal pressure of the sealed container is substantially equal to the second target pressure; and
dispensing, into a second drink container, (1) the second flavoring material from the drink dispenser system and (2) the additional liquid from the sealed container of the carbonator.

4. The method of claim 2, further comprising receiving the first single-use package of the first flavoring material in a flavor dispensing assembly of the drink dispenser system, the flavor dispensing assembly configured to dispense the first flavoring material into the first drink container.

5. The method of claim 1, further comprising determining an amount of carbon dioxide remaining in the carbon dioxide source after the release of the pressurized carbon dioxide from the carbon dioxide source into the sealed container has been completed.

6. The method of claim 5, wherein determining the amount of carbon dioxide remaining the carbon dioxide source after the release of the pressurized carbon dioxide from the carbon dioxide source into the sealed container has been completed comprises:
determining a first time when the pressurized carbon dioxide from the carbon dioxide source began to be released from the carbon dioxide source into the sealed container holding the predetermined amount of liquid;
determining a second time when release of the pressurized carbon dioxide from the carbon dioxide source into the sealed container was completed;
determining a carbon dioxide release time by determining a difference between the first time and the second time; and
determining the amount of carbon dioxide remaining in the carbon dioxide source after the release of the pressurized carbon dioxide from the carbon dioxide source into the sealed container has been completed based on the carbon dioxide release time.

7. The method of claim 5, further comprising displaying an alert on an interface of the drink dispenser system when the amount of carbon dioxide remaining in the carbon dioxide source, as determined, is below a predetermined level.

8. A drink dispenser system, comprising:
a carbonator including a sealed container configured to hold liquid, and a pressure sensor configured to determine an internal pressure of the sealed container; and
a controller including a processor, the controller being configured to:
identify a first predetermined carbonation level associated with a first flavoring material;
set a first target pressure of the sealed container for a predetermined amount of the liquid in the sealed container, the first target pressure of the sealed container being based on the first predetermined carbonation level and selected from a plurality of different target pressures;
coordinate releasing the pressurized carbon dioxide into the sealed container when the sealed container is holding the predetermined amount of liquid;
determine an internal pressure of the sealed container as the pressurized carbon dioxide is released into the sealed container;
coordinate inhibiting release of pressurized carbon dioxide from a carbon dioxide source into the sealed container when the internal pressure of the sealed container is substantially equal to the first target pressure; and
coordinate dispensing the liquid and the first flavoring material from one or more dispensing assemblies into a first drink container.

9. The drink dispenser system of claim 8, further comprising:
a code reader configured to read a code on a single-use package of flavoring material, wherein the controller including the processor is further configured to identify the first predetermined carbonation level associated with a first flavoring material based on a first code on a first single-use package of the first flavoring material, as read by the code reader.

10. The drink dispenser system of claim 9, wherein for a second predetermined amount of liquid, the controller including a processor is further configured to:
determine a second predetermined carbonation level associated with a second flavoring material based on a second code on a second single-use package of second flavor material, as read by the code reader, the second predetermined carbonation level being different than the first predetermined carbonation level;
set a second target pressure of the sealed container when the sealed container is holding the second predetermined amount of the additional liquid based on the second predetermined carbonation level and selected from the plurality of different target pressures;
coordinate releasing pressurized carbon dioxide from the carbon dioxide source into the sealed container when the sealed container is holding the second predetermined amount of the additional liquid therein;
determine the internal pressure of the sealed container as the additional pressurized carbon dioxide is inserted into the sealed container;
coordinate inhibiting release of the additional pressurized carbon dioxide from the carbon dioxide source into the sealed container when the internal pressure of the sealed container is substantially equal to the second target pressure; and
coordinate dispensing, into a second drink container, the additional liquid and the second flavoring material from the one or more dispensing assemblies.

11. The drink dispenser system of claim 9, wherein the one or more dispensing assemblies comprise at least a flavoring dispensing assembly configured to receive the first single-use package of the first flavoring material and dispense the first flavoring material into the first drink container.

12. The drink dispenser system of claim 8, wherein the controller including the processor is further configured to determine an amount of carbon dioxide remaining in the carbon dioxide source after the release of the pressurized carbon dioxide from the carbon dioxide source into the sealed container has been inhibited.

13. The drink dispenser system of claim 12, wherein the controller including the processor is configured to determine the amount of carbon dioxide remaining in the carbon dioxide source after the release of the pressurized carbon dioxide from the carbon dioxide source into the sealed container has been inhibited by:
determining a first time when the pressurized carbon dioxide from the carbon dioxide source began to be released from the carbon dioxide source into the sealed container holding the predetermined amount of liquid;
determining a second time when release of the pressurized carbon dioxide from the carbon dioxide source into the sealed container was inhibited;
determining a carbon dioxide release time by determining a difference between the first time and the second time; and
determining the amount of carbon dioxide remaining the carbon dioxide source after the release of the pressurized carbon dioxide from the carbon dioxide source into the sealed container has been inhibited using the carbon dioxide release time.

14. The drink dispenser system of claim 12, wherein the controller including the processor is configured display an alert on an interface of the controller when the amount of carbon dioxide remaining in the carbon dioxide source, as determined, is below a predetermined level.

15. A method of determining an amount of carbon dioxide in a carbon dioxide tank of a drink dispenser system, comprising:
releasing pressurized carbon dioxide from the carbon dioxide tank of the drink dispenser system into a sealed container of a carbonator of the drink dispenser system holding a predetermined amount of liquid until an internal pressure of the sealed container is substantially equal to a first target pressure;
determining a first time when the pressurized carbon dioxide from the carbon dioxide tank began to be released from the carbon dioxide tank into the sealed container holding the predetermined amount of liquid therein;
determining a second time when release of the pressurized carbon dioxide from the carbon dioxide tank into the sealed container was inhibited;
determining a carbon dioxide release time by determining a difference between the first time and the second time; and
determining the amount of carbon dioxide remaining in the carbon dioxide tank after the release of the pressurized carbon dioxide from the carbon dioxide tank into the sealed container has been inhibited using the carbon dioxide release time.

16. The method of claim 15, wherein determining the amount of carbon dioxide remaining in the carbon dioxide tank after the release of the pressurized carbon dioxide from the carbon dioxide tank into the sealed container has been inhibited using at least the carbon dioxide release time comprises using at least the carbon dioxide release time, an empty weight of the carbon dioxide tank when the carbon dioxide tank is empty, a filled weight of the carbon dioxide tank when the carbon dioxide tank is initially filled, an ambient temperature proximate to the dioxide tank, the first target pressure, and an amount of carbon dioxide required to pressurize the sealed container to the first target pressure.

17. The method of claim 15, wherein determining the amount of carbon dioxide remaining in the carbon dioxide tank after the release of the pressurized carbon dioxide from the carbon dioxide tank into the sealed container has been inhibited using at least the carbon dioxide release time comprises comparing the carbon dioxide release time to a carbonation time profile for the first target pressure.

18. The method of claim 15, further comprising displaying an alert on an interface of a controller of the drink dispenser system when the amount of carbon dioxide remaining in the carbon dioxide tank, as determined, is below a predetermined level.

19. The method of claim 15, further comprising:
reading a first code on a first single-use package of a first flavoring material;
receiving the first single-use package of the first flavoring material in a flavor dispensing assembly of the drink dispenser system, the flavor dispensing assembly configured to dispense the first flavoring material into a first drink container;
receiving, in the sealed container of the carbonator of the drink dispenser system, the predetermined amount of liquid from a reservoir of the drink dispenser system;
identifying, with a processor of a controller of the drink dispenser system, a first predetermined carbonation level associated with a first flavoring material based on the first code on the first single-use package of the first flavoring material;
setting the first target pressure of the sealed container holding the predetermined amount of the liquid therein based on the first predetermined carbonation level, the first target pressure being selected from a plurality of different target pressures;
determining an internal pressure of the sealed container as the pressurized carbon dioxide is inserted into the sealed container;
inhibiting release of the pressurized carbon dioxide from the carbon dioxide tank into the sealed container when the internal pressure of the sealed container is substantially equal to the first target pressure; and
dispensing, into the first drink container, (1) the first flavoring material from the flavor dispensing assembly and (2) the liquid, as carbonated, from the sealed container of the carbonator.

20. The method of claim 19, further comprising:
reading a second code on a second single-use package of a second flavoring material;
receiving the second single-use package of the second flavoring material in the flavor dispensing assembly;
receiving, in the sealed container of the carbonator of a drink dispenser system, an additional predetermined amount of additional liquid from the reservoir of the drink dispenser system;
identifying, with the processor, a second predetermined carbonation level associated with the second flavoring material based on the second code on the second single-use package of the second flavoring material, the second predetermined carbonation level being different than the first predetermined carbonation level;
setting a second target pressure of the sealed container holding the additional predetermined amount of the additional liquid therein based on the second predetermined carbonation level, the second target pressure being (1) different than the first target pressure and (2) selected from the plurality of different target pressures;
releasing additional pressurized carbon dioxide from the carbon dioxide tank of the drink dispenser system into the sealed container holding the additional predetermined amount of the additional liquid therein;
determining the internal pressure of the sealed container as the additional pressurized carbon dioxide is inserted into the sealed container;
inhibiting release of the additional pressurized carbon dioxide from the carbon dioxide tank into the sealed container when the internal pressure of the sealed container is substantially equal to the second target pressure; and
dispensing, into a second drink container, (1) the first flavoring material from the drink dispenser system and (2) the additional liquid, as carbonated, from the sealed container of the carbonator.
